(19) United States
(12) Patent Application Publication
(10) Pub. No.: US 2026/0101412 A1
(43) Pub. Date: Apr. 9, 2026

(54) TRANSMISSION OF APPLICATION DATA

(71) Applicant: Nokia Technologies Oy, Espoo (FI)

(72) Inventors: Srinivasan SELVAGANAPATHY, Bangalore (IN); Mads LAURIDSEN, Aalborg (DK); Jeroen WIGARD, Aalborg (DK); Ping YUAN, Beijing (CN); Xiang XU, Beijing (CN)

(21) Appl. No.: 19/115,239

(22) PCT Filed: Sep. 29, 2022
(86) PCT No.: PCT/CN2022/122912

§ 371 Date: Mar. 25, 2025

(51) Int. Cl. H04W 76/30; H04L 1/18; H04W 76/28

(52) U.S. Cl. CPC H04W 76/30; H04L 1/18; H04W 76/28

(57) ABSTRACT

Embodiments of the present disclosure relate to data transmission for discontinuous connectivity. A terminal device receives, from an access network device, an indication that an acknowledgement for application data from the terminal device is to be deferred. The terminal device avoids retransmitting the application data based on the indication. As such, redundant retransmissions of the application data can be avoided.

### FIELD

Various example embodiments relate to the field of telecommunication and in particular, to methods, devices, apparatuses and a computer readable storage medium for transmission of application data.

### BACKGROUND

A communication system can be seen as a facility that enables communication sessions between two or more entities such as terminal devices, base stations and/or other nodes by providing carriers between the various entities involved in the communication path. The communication sessions may be used for providing services comprising two-way or multi-way calls, data communication or multimedia services and access to an application server via a data network system, such as the Internet.

However, transmission of application data between the terminal devices and the application server may suffer from discontinuous connectivity between the entities in the communication path. For example, the discontinuous connectivity may cause delay in the communication sessions. Thus solutions for transmission of application data are needed to reduce the side-effect of the discontinuous connectivity.

### SUMMARY

In general, example embodiments of the present disclosure provide a solution for transmission of application data.

In a first aspect, there is provided a terminal device. The terminal device comprises at least one processor and at least one memory storing instructions that, when executed by the at least one processor, cause the terminal device at least to: receive, from an access network device, an indication that an acknowledgement for application data from the terminal device is to be deferred; and avoid retransmitting the application data based on the indication.

In a second aspect, there is provided an access network device. The access network device comprises at least one processor; and at least one memory storing instructions that, when executed by the at least one processor, cause the access network device at least to: determine, at the access network device, that an acknowledgement for application data from a terminal device is to be deferred; and transmit, to the terminal device, an indication that the acknowledgement is to be deferred, the terminal device being configured to avoid retransmitting the application data based on the indication.

In a third aspect, there is provided a method. The method comprises receiving, at a terminal device and from an access network device, an indication that an acknowledgement for application data from the terminal device is to be deferred; and avoiding, at the terminal device, retransmitting the application data based on the indication.

In a fourth aspect, there is provided a method. The method comprises determining, at an access network device, that an acknowledgement for application data from a terminal device is to be deferred; and transmitting, to the terminal device, an indication that the acknowledgement is to be deferred, the terminal device being configured to avoid retransmitting the application data based on the indication.

In a fifth aspect, there is provided an apparatus comprising: means for receiving, at a terminal device and from an access network device, an indication that an acknowledgement for application data from the terminal device is to be deferred; and means for avoiding, at the terminal device, retransmitting the application data based on the indication.

In a sixth aspect, there is provided an apparatus comprising: means for determining, at an access network device, that an acknowledgement for application data from a terminal device is to be deferred; and means for transmitting, to the terminal device, an indication that the acknowledgement is to be deferred, the terminal device being configured to avoid retransmitting the application data based on the indication.

In a seventh aspect, there is provided a non-transitory computer readable medium comprising program instructions for causing an apparatus to perform at least the method according to any one of the above third to fourth aspect.

In an eighth aspect, there is provided a computer program comprising instructions, which, when executed by an apparatus, cause the apparatus at least to: receive, at a terminal device and from an access network device, an indication that an acknowledgement for application data from the terminal device is to be deferred; and avoid, at the terminal device, retransmitting the application data based on the indication.

In a ninth aspect, there is provided a computer program comprising instructions, which, when executed by an apparatus, cause the apparatus at least to: determine, at an access network device, that an acknowledgement for application data from a terminal device is to be deferred; and transmit, to the terminal device, an indication that the acknowledgement is to be deferred, the terminal device being configured to avoid retransmitting the application data based on the indication.

In a tenth aspect, there is provided a terminal device comprising: receiving circuitry configured to receive, at a terminal device and from an access network device, an indication that an acknowledgement for application data from the terminal device is to be deferred; and avoiding circuitry configured to avoid, at the terminal device, retransmitting the application data based on the indication.

In an eleventh aspect, there is provided an access network device comprising: determining circuitry configured to determine, at an access network device, that an acknowledgement for application data from a terminal device is to be deferred, the access network device; and transmitting circuitry configured to transmit, to the terminal device, an indication that the acknowledgement is to be deferred, the terminal device being configured to avoid retransmitting the application data based on the indication.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication network in which embodiments of the present disclosure may be implemented;

FIG. 2 illustrates an example of a process of transmission of application data according to some embodiments of the present disclosure;

FIG. 3 illustrates an example of a process of data transmission for discontinuous connectivity with a RRC connection according to some embodiments of the present disclosure;

FIG. 4 illustrates an example of a process of data transmission for discontinuous connectivity with an indication of store-and-forward mode according to some embodiments of the present disclosure;

FIG. 5 illustrates an example of a process of data transmission for discontinuous connectivity with a token according to some embodiments of the present disclosure;

FIG. 6 illustrates a flowchart of a method implemented at a terminal device according to some embodiments of the present disclosure;

FIG. 7 illustrates a flowchart of a method implemented at an access network device according to some embodiments of the present disclosure;

FIG. 8 illustrates a simplified block diagram of an apparatus that is suitable for implementing embodiments of the present disclosure; and

FIG. 9 illustrates a block diagram of an example computer readable medium in accordance with some embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), Narrow Band Internet of Things (NB-IOT), enhanced machine type communication (eMTC, also known as LTE-M) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the future fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay, a low power node such as a femto, a pico, and so forth, depending on the applied terminology and technology.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

As mentioned above, the communication sessions may suffer from discontinuous connectivity between the entities in the communication path. For example, when cellular coverage is provided from non-terrestrial base stations, such as gNBs or eNBs in satellites, there will be discontinuity of coverage situation for the terminal device depending on the coverage foot-print and number of satellites. Moreover, when the base stations are deployed as the gNBs or eNBs in the satellites, discontinuous connectivity may occur between the base stations and the core network due to, for example, movement of the satellites. In this case, the discontinuous connectivity may cause failure of the data transmission between the terminal device and the core network.

The store-and-forward mode has been proposed to improve the data transmission in the discontinuous connectivity scenarios. In the store-and-forward mode, data packets can be stored at the access network device, e.g., gNBs or eNBs in the satellites, and forwarded to the terminal device or the core network when corresponding connectivity is available.

However, in the store-and-forward mode, the terminal device which expects an acknowledgement for application data may conduct a redundant retransmission of the application data if it does not receive the acknowledgement in a timely manner. For example, when receiving the acknowledgement via the core network, the access network device may have no connectivity with the terminal device, e.g., due to a long distance with the terminal device. In this case, the access network device may not be able to transmit the acknowledgment to the terminal device until it has next connectivity with the terminal device. Thus the terminal device, which is waiting for the acknowledgement, may keep attempting to retransmit the application data until it receives the acknowledgement. In other words, due to non-availability of application server connectivity at the time of radio connectivity, the terminal device may keep retransmitting the application data until it receives the acknowledgement for the application data. This is inefficient and resource-consuming.

According to embodiments of the present disclosure, there is providing a solution for transmission of application data. In this solution, a terminal device receives, from an access network device, an indication that an acknowledgement for application data from the terminal device is to be deferred. The terminal device avoids retransmitting the application data based on the indication. As such, the terminal device may avoid a redundant retransmission of the application data.

Principle and embodiments of the present disclosure will be described in detail below with reference to the accompanying drawings. However, it is to be noted that these embodiments are illustrated as examples and not intended to limit scope of the present application in any way.

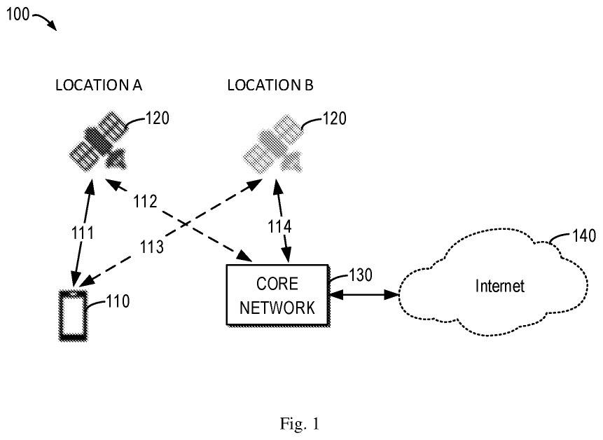

Reference is first made to FIG. 1, which illustrates an example communication system 100 in which embodiments of the present disclosure may be implemented. FIG. 1 illustrates an example system, comprising a terminal device 110, an access network device 120, a core network 130 and a data network 140, e.g., the Internet.

In some embodiments, the access network device 120 may be a radio access network (RAN) device. The access network device 120 may be in a non-terrestrial network (NTN). The NTN refers to networks that can provide connectivity to a core network, e.g., the core network 130, through space-borne vehicles (such as satellites) and/or through airborne platforms, thereby providing radio connectivity between a terminal device, e.g., the terminal device 110, on the ground and the vehicle/platform. For example, the access network device 120 may be a gNB or eNB in the satellite.

In some embodiments, the terminal device 110 may be an Internet of Things (IoT) device. In release 17, the NTN has been defined for New Radio, Narrow Band (NB)-IoT, and eMTC devices. The NTN may enable the communication sessions between the terminal device 110 and the core network 130 efficiently due to attributes of IOT data traffic, such as small data transmission (SDT) with few packets, early data transmission (EDT), preconfigured uplink resources (PUR) and/or non-critical delivery time.

In some embodiments, the core network 130 may be a 4G Evolved Packet Core (EPC) network. The access network device 120 may provide connectivity to a Mobility Management Entity (MME) or a Serving-gateway (S-GW) in the EPC network. In some embodiments, the core network 130 may be a 5G core network. The access network device 120 may provide connectivity to an Access and Mobility Management Function (AMF) in the 5G core network.

As shown in FIG. 1, the access network device 120 may have discontinuous connectivity with the core network 130 (as shown in dashed lines). For example, when the access network device 120 is located at location A, the access network device 120 may have connectivity 111 with the terminal device 110 while having no connectivity 112 with the core network 130. The access network device 120 may receive application data from the terminal device 110 at the location A and store the application data. As the access network device 120 moves from the location A to location B, the access network device 120 may have no connectivity 113 with the terminal device 110 while having connectivity 114 with the core network 130. Alternatively, at the location B, the access network device 120 may have both of the connectivity 113 with the terminal device 110 and the connectivity 114 with the core network 130. With connectivity to the core network 130, the access network device 120, at the location B, may transmit the stored application data to the application server via the data network 140.

It is to be appreciated that this particular arrangement of system elements is an example only, and other types and arrangements of additional or alternative elements can be used to implement a communication system in other embodiments. For example, the access network device 120 having discontinuous connectivity with the core network 130 may be in a public land mobile network (PLMN) instead of the NTN.

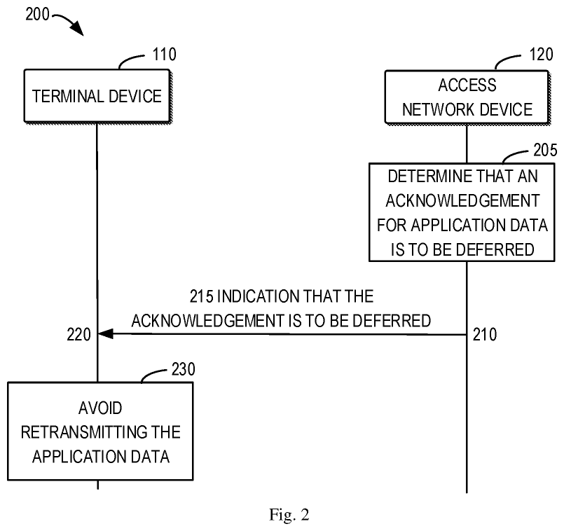

Reference is now made to FIG. 2, which shows an example of a process 200 of data transmission according to an embodiment of the present disclosure. It would be appreciated that the process 200 may be applied to the communication system 100 of FIG. 1 and any other similar communication scenarios. The process 200 may be described with reference to FIG. 1.

In the process 200, the access network device 120 determines 205 that an acknowledgement for application data from the terminal device 110 is to be deferred. The acknowledgement to be deferred may refer to the acknowledgement to be delayed or to be delivered at a later time than expected or than in normal scenarios. The acknowledgement for the application data may be generated from the application server in connection with the core network 130.

In some embodiments, the acknowledgement may be deferred due to discontinuous connectivity between the access network device 120 and the core network 130, as discussed with reference to FIG. 1. For example, when the access network device 120 has connectivity 111 with the terminal device 110, it may receive the application data from the terminal device 110. However, due to no connectivity 112 with the core network 130, the access network device 120 may not transmit the application data to the core network 130 and thus may not receive the acknowledgement from the application server. Thus delivery of the acknowledgement to the terminal device 110 may be deferred.

In some embodiments, the access network device 120 may determine 205 that the acknowledgement is to be deferred when it operates in the store-and-forward mode. Alternatively or in addition, the access network device 120 may determine 205 that the acknowledgement is to be deferred based on predetermined movement of the access network device 120. For example, the access network device 120 may determine that it will lose connectivity with the core network 130 due to the movement and thus receipt of the acknowledgement via the core network 130 is to be deferred.

Alternatively or in addition, the access network device 120 may determine 205 that the acknowledgement is to be deferred based on current connectivity with the core network 130. For example, the access network device 120 may determine 205, based on decreasing connectivity with the access network device 120, that it will lose connectivity with the core network 130 and thus the acknowledgement is to be deferred.

In accordance with the determination 205, the access network device 120 transmits 210, to the terminal device 110, an indication 215 that the acknowledgement is to be deferred. In some embodiments, the indication 215 may comprise information indicating that the access network device 120 is in the store-and-forward mode. In other words, the access network device 120 may inform the terminal device 110 that it is operating in the store-and-forward mode, so as to indicate that it has discontinuous connectivity with the core network 130 and thus the acknowledgement for the application data is to be deferred. Alternatively or in addition, the indication 215 may comprise information indicating that a packet from the terminal device 110 is stored in the access network device 120 for forwarding.

Alternatively or in addition, the indication 215 may comprise a resume time indicating a time for delivery of the acknowledgement. In other words, the indication 215 may comprise information indicating when the acknowledgement is to be delivered to the terminal device 110. The time for delivery of the acknowledgement may be an expected time, e.g., determined based on knowledge about satellite movement and core network connectivity. The indication 215 may further comprise information indicating an identifier of the access network device 120, e.g., the satellite, for delivery of the acknowledgement.

Alternatively or in addition, the indication 215 may comprise a token generated based on a number of previous data transmissions between the terminal device 110 and the core network 130. The token generated based on the number of previous data transmissions may indicate that successful data transmissions have been conducted between the terminal device 110 and the core network 130. Thus the token may be used to indicate that the application data from the terminal device 110 is to be transmitted to the application server successfully.

In some embodiments, the access network device 120 may transmit 210 the indication 215 to the terminal device 110 prior to receiving the application data from the terminal device 110. In other words, the terminal device 110 may first receive 220 the indication 215 and be informed that if it transmits application data to the application server via the access network device 120, the acknowledgement for the application data may be deferred. In this case, after transmitting the application data, the terminal device 110 would not retransmit the application data even though it does not receive the acknowledgement from the application server.

Alternatively, the access network device 120 may transmit 210 the indication 215 to the terminal device 110 after receiving the application data from the terminal device 110. The access network device 120 may transmit 210 the indication 215 to the terminal device 110 prior to forwarding the application data to the core network 130 or after forwarding the application data to the core network 130.

The terminal device 110 receives 220 the indication 215 from the access network device 120. Based on the indication 215, the terminal device 110 avoids 230 retransmitting the application data.

In some embodiments, the terminal device 110 may receive 220 the indication 215 via a radio resource control (RRC) connection release message. The terminal device 110 may establish a RRC connection with the access network device 120 and transmit the application data to the access network device 120 in a RRC connected mode. When the access network device 120 determines 205 that the acknowledgement is to be deferred, e.g., based on current connectivity with the core network 130, the access network device 120 may transmit 210 the indication 215 to the terminal device 110 via a RRC connection release message. In other words, when transmitting the RRC connection release message to the terminal device 110 to release it into a RRC idle or inactive mode, the access network device 120 may further inform the terminal device 110 that the acknowledgement for the transmitted application data is to be deferred.

Additionally, in a case where the terminal device 110 transmits the application data in a RRC connected mode, the terminal device 110 may further transmit release assistance information (RAI) indicating that a final packet for the application data is transmitted and the acknowledgement for the application data is pending. The terminal device 110 may receive, from the access network device 120, the RRC connection release message comprising a resume time indicating a time for delivery of the acknowledgement. In other words, the terminal device 110 may further transmit the RAI in order to obtain the resume time for the delivery of the acknowledgement. In some embodiments, the RAI may be generated by the AS layer of the terminal device 110 with a flag indicating that the final packet is transmitted and the acknowledgement is pending. The reserved bits of the RAI may be used for this purpose.

In some embodiments, prior to receiving the RRC connection release message containing the resume time, the terminal device 110 may receive, from the access network device 120, pending downlink data that the access network device 120 received from the core network 130 during last connectivity between the core network 130 and the access network device 120. In other words, in a case where the access network device 120 has pending downlink data, the access network device 120 may transmit the pending downlink data prior to transmitting the RRC connection release message.

In some embodiments, in a case where the terminal device 110 transmits the application data in a RRC connection resume request, the terminal device 110 may further transmit, in the RRC connection resume request, the RAI indicating that a downlink packet is expected. Thus, the terminal device 110 may receive 220 the indication 215 via a RRC connection release message. Alternatively, the terminal device 110 may receive 220 the indication 215 via a contention resolution message.

In some embodiments, the terminal device 110 may receive 220 the indication 215 via system information. For example, in a case where the access network device 120 is operating in the store-and-forward mode, the access network device 120 may broadcast the system information containing information indicating the store-and-forward mode. Thus the terminal device 110 may receive 220 the indication 215 prior to transmitting the application data to the access network device 120.

Alternatively or in addition, the terminal device 110 may receive 220 the indication 215 via a random access response (RAR) message. For example, in a case where the terminal device 110 initiates a random access procedure, the access network device 120 may transmit the RAR message containing information indicating the store-and-forward mode. Thus the terminal device 110 may be informed that the acknowledgement is to be deferred prior to transmitting the application data in a RRC early data transmission request.

Alternatively or in addition, the terminal device 110 may receive 220 the indication 215 via a connection resolution message. For example, in a case where the terminal device 110 initiates a random access procedure and transmits the application data as a non-access stratum (NAS) message in a RRC early data transmission request, the access network device 120 may transmit 210, to the terminal device 110, the connection resolution message containing the token generated based on the previous data transmission between the terminal device 110 and the core network 130. Thus the terminal device 110 may be informed that the acknowledgement for the transmitted application data is to be deferred.

In some embodiments, the token may be generated based on the number of previous early data transmissions associated with an attach procedure or a previous NAS message. The token may be generated by the core network 130. The token may be generated based on an s-temporary mobile subscription identifier (S-TMSI) for the terminal device and the number of previous early data transmissions between the terminal device and the core network.

In some embodiments, upon receiving 220 the indication 215 and prior to retransmission of the application data, an access stratum (AS) layer of the terminal device 110 may indicate, to an application layer of the terminal device 110, delivery confirmations for a plurality of packets for the application data given the AS layer. In other words, the AS layer informs the application layer that the packets have been delivered and retransmission of the packets is not needed. Alternatively or in addition, the AS layer may indicate the application layer to wait for, e.g., based on the resume time, the deferred acknowledgement and not retransmit the packets for the application data.

Alternatively, upon receiving 220 the indication 215, the AS layer may indicate, to the application layer, a delivery confirmation for each packet data convergence protocol service data unit (PDCP SDU) for the application data with an indication to wait for, e.g., based on the resume time, the deferred acknowledgement. In other words, the delivery confirmation may be specific to each PDCP SDU for the application data.

In some embodiments, the terminal device 110 may further receive, from the access network device 120, auto resume information indicating the terminal device 110 to trigger an early data transmission, EDT, procedure or a RRC connection procedure to obtain the acknowledgement during next connectivity with the access network device 120 without waiting for paging. In some embodiments, the terminal device 110 may receive the auto resume information via a RRC connection release message or system information.

With the auto resume information, the terminal device 110 may directly trigger the EDT procedure or RRC connection procedure to obtain the acknowledgement when the connectivity between the terminal device 110 and the access network device 120 is reestablished. For example, when the access network device 120 moves to the location A again, the terminal device 110 may trigger the EDT procedure or RRC connection procedure without waiting for paging.

In some embodiments, the terminal device 110 may receive a duration from the access network device 120 and trigger the EDT procedure or the RRC connection procedure to obtain the acknowledgement after the duration from receipt of the acknowledgement. In this case, the terminal device 110 may be informed when it can obtain the acknowledgement.

In some embodiments, the terminal device 110, based on the indication 215, may avoid 230 retransmitting the application data by avoiding retransmitting the application data at least in a time period. The terminal device 110 may avoid retransmitting the application data until receiving an indication of retransmitting the application data. Alternatively or in addition, the terminal device 110 may avoid retransmitting the application data in a time period and start the retransmission after the time period. The time period may be associated with or determined from the indication 215, e.g., the resume time. Alternatively or in addition, the terminal device 110 may start a timer based on receiving the indication 215. The terminal device 110 may attempt to retransmit the application data when the timer expires. In other words, the terminal device 110 may postpone the retransmission of the application data based on the indication 215.

In this way, with the process 200, the terminal device 110 may be informed that the acknowledgement for the application data to be transmitted or the transmitted application data is to be deferred. Thus the redundant retransmission of the application data can be avoided.

It is to be noted that, the acknowledgement may be deferred due to reasons other than the discontinuous connectivity. For example, the acknowledgement may be deferred due to heavy congestion to a certain application in the communication path to the application server. The congestion may occur anywhere along the communication path. In this case, the process 200 may be applied to other communication systems other than the communication system 100 in a discontinuous connectivity scenario of FIG. 1.

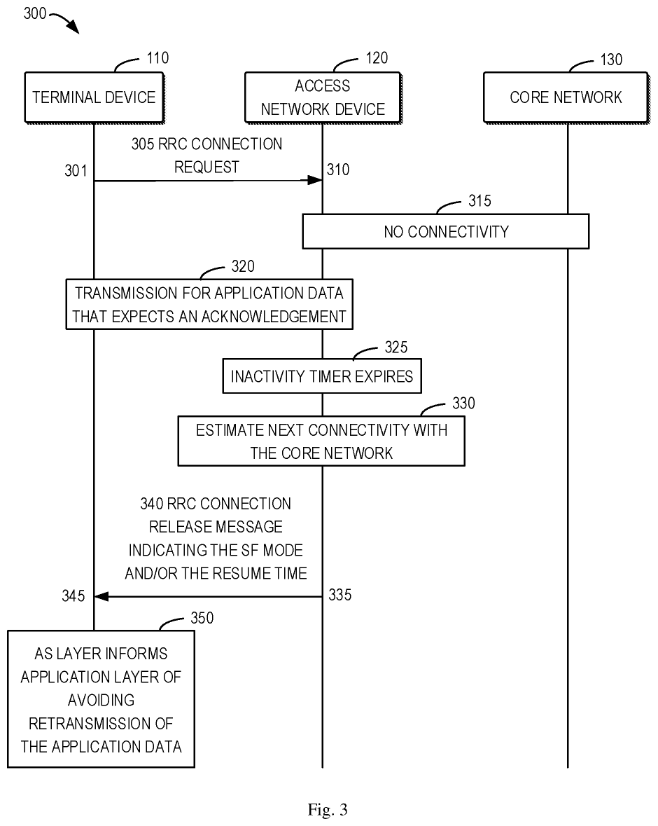

FIG. 3 illustrates an example of a process 300 of data transmission for discontinuous connectivity with a RRC connection according to an embodiment of the present disclosure. It is noted that the process 300 can be deemed as a more specific example of the process 200. It would be appreciated that the process 300 may be applied to the communication system 100 of FIG. 1 and any other similar communication scenarios.

As shown in FIG. 3, the terminal device 110 transmits 301 a RRC connection request 305 to the access network device 120 to initiate a RRC connection setup procedure. The access network device 120 receives 310 the request and establishes a RRC connection with the terminal device 110. The access network device 120 may determine 315 that it has no connectivity with the core network 130 and operates in the store-and-forward mode. With the RRC connection, the terminal device 110 may perform 320 transmissions for the application data which expects a corresponding acknowledgement from the application server. The access network device 120 may store the application data. The access network device 120 may determine 325 that inactivity timer expires and thus determine to release the RRC connection. Alternatively or in addition, the access network device 120 may determine to release the RRC connection based on a buffer status report from the terminal device 110.

Based on the determination, the access network device 120 may estimate 330 next connectivity with the core network 130, so as to determine the resume time indicating a time for delivery of the acknowledgement. The access network device 120 may transmit 335, to the terminal device 110, a RRC connection release message 340 indicating the store-and-forward (SF) mode and/or the resume time to inform the terminal device 110 that the acknowledgement for the application data is to be deferred. The terminal device 110 may receive 345 the RRC connection release message 340 containing the indication 215 and avoid retransmitting the application data. The AS layer of the terminal device 110 may inform 350 the application layer of the terminal device 110 of avoiding retransmission of the application data. Thus the application layer may not attempt to initiate another RRC connection procedure with the access network device 120.

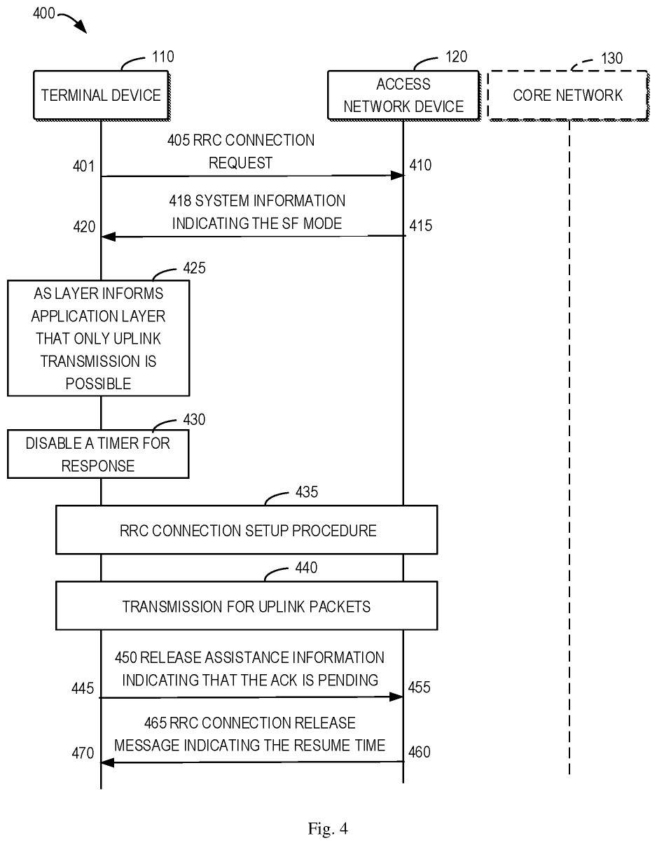

FIG. 4 illustrates an example of a process 400 of data transmission for discontinuous connectivity with an indication of store-and-forward mode according to an embodiment of the present disclosure. It is noted that the process 400 can be deemed as a more specific example of the process 200. It would be appreciated that the process 400 may be applied to the communication system 100 of FIG. 1 and any other similar communication scenarios.

As shown in FIG. 4, the terminal device 110 transmits 401 a RRC connection request 405 to the access network device 120 to initiate a RRC connection setup procedure. The access network device 120 receives 410 the request and establishes the RRC connection with the terminal device 110. The access network device 120 may transmit 415, to the terminal device 110, system information 418 indicating that the access network device 120 is operating in the store-and-forward mode. The terminal device 110 may receive 420 the system information 418 and be informed that the access network device 120 is operating in the store-and-forward mode and that the acknowledgement for any application data may be deferred. The AS layer of the terminal device 110 may inform 425 the application layer of the terminal device 110 that only uplink transmission is possible. The terminal device 110 may disable 430, modify or stop its timer for retransmission as a response to the received system information 418.

The terminal device 110 may further perform 435 a RRC connection setup procedure and establishes the RRC connection with the access network device 120. In the RRC connected mode, the terminal device 110 may perform 440 transmissions for uplink packets for the application data. The terminal device 110 may further transmit 445, to the access network device 120, the RAI 450 indicating that the final packet is transmitted and the acknowledgement is pending. The access network device 120 may receive 455 the RAI 450 and determine to release the RRC connection. The access network device 120 may transmit 460, to the terminal device 110, a RRC connection release message 465 to release the RRC connection. The RRC connection release message 465 may further comprise the resume time. The terminal device 110 may receive 470 the RRC connection release message 465 and be informed that when the acknowledgement is to be delivered.

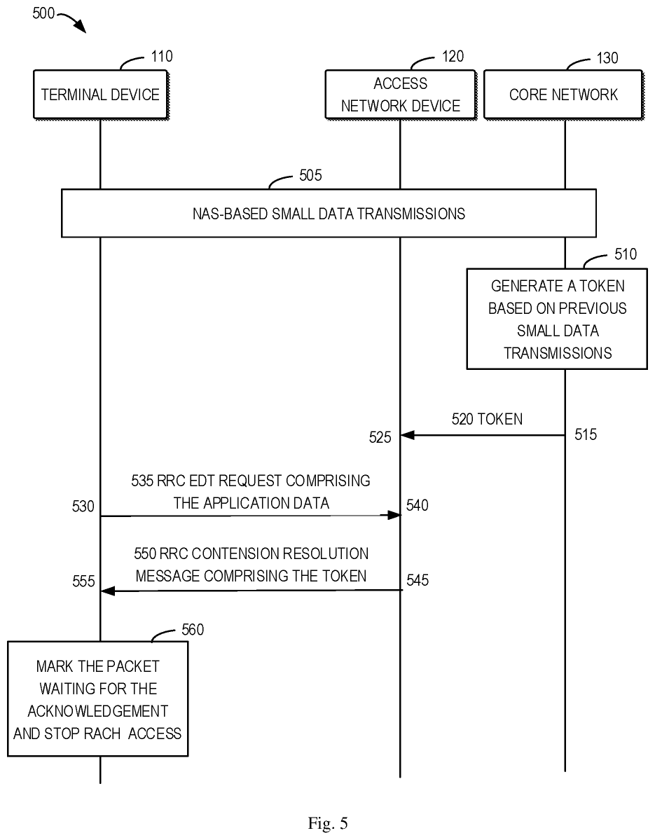

FIG. 5 illustrates an example of a process 500 of data transmission for discontinuous connectivity with a token according to an embodiment of the present disclosure. It is noted that the process 500 can be deemed as a more specific example of the process 200. It would be appreciated that the process 500 may be applied to the communication system 100 of FIG. 1 and any other similar communication scenarios.

As shown in FIG. 5, a number of NAS-based small data transmissions are conducted 505 between the terminal device 110 and the core network 130. The NAS-based small data transmissions may be associated with previous NAS messages. The core network 130 may generate 510 a token based on the previous small data transmissions. For example, the token may be generated based on S-TMSI for the terminal device 110 and a count of the successful early data transmissions (e.g., mobile-originated, MO-EDT-COUNT). The core network 130 may transmit 515 the token 520 to the access network device 120. The access network device 120 receives 525 the token and may store the token as the indication 215 that the acknowledgement is to be deferred.

The terminal device 110 may perform an early data transmission procedure to transmit the application data. The terminal device 110 may transmit 530 a RRC EDT request 535 comprising the application data as a NAS message. The access network device 120 may receive 540 the request and transmit 545 a RRC contention resolution message 550 comprising the token to indicate that the acknowledgement for the transmitted application data is to be deferred. The terminal device 110 may receive 555 the RRC contention resolution message 550 and be informed that the acknowledgement is to be deferred. The terminal device 110 may avoid retransmitting the application data by marking 560 the packet waiting for the acknowledgement and stopping the random access control channel (RACH) access.

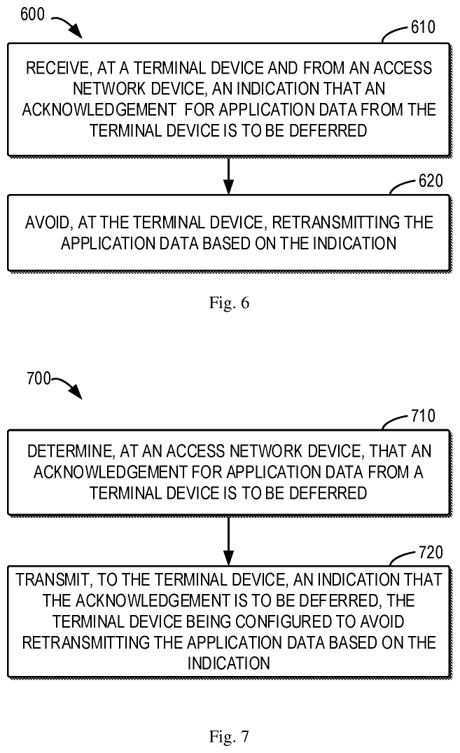

FIG. 6 shows a flowchart of an example method 600 implemented at a terminal device in accordance with some embodiments of the present disclosure. For the purpose of discussion, the method 600 will be described from the perspective of the terminal device 110 with reference to FIG. 1.

At block 610, the terminal device 110 receives, from an access network device 120, an indication that an acknowledgement for application data from the terminal device is to be deferred. At block 620, the terminal device 110 avoids retransmitting the application data based on the indication.

In some embodiments, the access network device has discontinuous connectivity with a core network.

In some embodiments, the indication comprises at least one of: information indicating that the access network device is in a store-and-forward mode, information indicating that a packet from the terminal device is stored in the access network device for forwarding, a resume time indicating a time for delivery of the acknowledgement, or a token generated based on a number of previous data transmissions between the terminal device and the core network.

In some embodiments, the terminal device 110 may receive the indication via at least one of: a radio resource control, RRC, connection release message, system information, a random access response, RAR, message or a contention resolution message.

In some embodiments, the terminal device 110 may further perform, prior to retransmission of the application data, at least one of the following based on receiving a RRC connection release message comprising the indication: indicating, to an application layer of the terminal device, delivery confirmations for a plurality of packets for the application data given to an access stratum, AS, layer of the terminal device, or indicating the application layer to wait for the deferred acknowledgement.

In some embodiments, the terminal device 110 may further perform at least one of the following based on receiving a RRC connection release message comprising the indication: indicating, to an application layer of the terminal device, a delivery confirmation for each packet data convergence protocol service data unit, PDCP SDU, for the application data with an indication to wait for the deferred acknowledgement.

In some embodiments, the terminal device 110 may receive the indication by: receiving system information or a RAR message indicating that the access network device is in a store-and-forward mode, prior to transmitting the application data to the access network device.

In some embodiments, the terminal device 110 may further transmit, to the access network device, release assistance information, RAI, indicating that a final packet for the application data is transmitted and the acknowledgement is pending; and receive, from the access network device, a RRC connection release message comprising a resume time indicating a time for delivery of the acknowledgement.

In some embodiments, the terminal device 110 may further generate, by an AS layer of the terminal device, the RAI with a flag indicating that the final packet for the application data is transmitted and the acknowledgement is pending.

In some embodiments, the terminal device 110 may further receive, from the access network device and prior to receiving the RRC connection release message, pending downlink data received from the core network during last connectivity between the core network and the access network device.

In some embodiments, the terminal device 110 may further transmit, to the access network device, a RRC connection resume request comprising the application data and RAI indicating that a downlink packet is expected, prior to receiving the indication via a RRC connection release message or via a contention resolution message.

In some embodiments, the terminal device 110 may further transmit, to the access network device, an early data transmission request comprising the application data as a non-access stratum, NAS, message, prior to receiving a contention resolution message comprising an token generated based on a number of previous early data transmissions between the terminal device and the core network.

In some embodiments, the number of previous early data transmissions are associated with an attach procedure or a previous NAS message.

In some embodiments, the token is generated based on an s-temporary mobile subscription identifier, S-TMSI, for the terminal device and the number of previous early data transmissions between the terminal device and the core network.

In some embodiments, the terminal device 110 may further receive, from the access network device, auto resume information indicating the terminal device to trigger an early data transmission, EDT, procedure or a RRC connection procedure to obtain the acknowledgement during next connectivity with the access network device without waiting for paging.

In some embodiments, the terminal device 110 may further receive a duration from the access network device; and trigger the EDT procedure or the RRC connection procedure to obtain the acknowledgement after the duration from receipt of the acknowledgement.

In some embodiments, the terminal device 110 may receive the auto resume information via a RRC connection release message or system information.

FIG. 7 shows a flowchart of an example method 700 implemented at an access network device in accordance with some embodiments of the present disclosure. For the purpose of discussion, the method 700 will be described from the perspective of the access network device 120 with reference to FIG. 1.

At block 710, the access network device 120 determines that an acknowledgement for application data from a terminal device 110 is to be deferred. At block 720, the access network device 120 transmits, to the terminal device 110, an indication that the acknowledgement is to be deferred, the terminal device being configured to avoid retransmitting the application data based on the indication.

In some embodiments, the access network device has discontinuous connectivity with a core network.

In some embodiments, the indication comprises at least one of: information indicating that the access network device is in a store-and-forward mode, information indicating that a packet from the terminal device is stored in the access network device for forwarding, a resume time indicating a time for delivery of the acknowledgement, or a token generated based on a number of previous data transmissions between the terminal device and the core network.

In some embodiments, the access network device 120 may transmit the indication via at least one of: a radio resource control, RRC, connection release message, system information, a random access response, RAR, message or a contention resolution message.

In some embodiments, the access network device 120 may further receive, from the terminal device, the application data in a RRC connected mode, prior to transmitting the indication to the terminal device via a RRC connection release message indicating at least one of information indicating that a packet from the terminal device is stored in the access network device for forwarding, or a resume time indicating a time for delivery of the acknowledgement.

In some embodiments, the access network device 120 may transmit the indication by: transmitting, to the terminal device, system information or a RAR message indicating that the access network device is in a store-and-forward mode prior to receiving the application data from the terminal device.

In some embodiments, the access network device 120 may further receive, from the terminal device, release assistance information, RAI, indicating that a final packet for the application data is transmitted and the acknowledgement is pending; and transmit, to the terminal device, a RRC connection release message comprising a resume time indicating a time for delivery of the acknowledgement.

In some embodiments, the access network device 120 may further transmit, to the terminal device and prior to transmitting the RRC connection release message, pending downlink data received from the core network during last connectivity between the core network and the access network device.

In some embodiments, the access network device 120 may further receive, from the core network, an token generated based on a number of previous early data transmissions between the terminal device and the core network; and receive, from the terminal device, an early data transmission request comprising the application data as a non-access stratum, NAS, message, prior to transmitting a contention resolution message comprising the token to the terminal device.

In some embodiments, the number of previous early data transmissions are associated with an attach procedure or a previous NAS message.

In some embodiments, the token is generated based on an s-temporary mobile subscription identifier, STMSI, for the terminal device and the number of previous early data transmissions between the terminal device and the core network.

In some embodiments, the access network device 120 may further transmit, to the terminal device, auto resume information indicating the terminal device to trigger an early data transmission, EDT, procedure or a RRC connection procedure to obtain the acknowledgement during next connectivity with the access network device without waiting for paging.

In some embodiments, the access network device 120 may further transmit a duration to the terminal device, the terminal device being configured to trigger the EDT procedure or the RRC connection procedure to obtain the acknowledgement after the duration from receipt of the acknowledgement.

In some embodiments, the access network device 120 may transmit the auto resume information via a RRC connection release message or system information.

In some embodiments, an apparatus capable of performing any of the method 600 (for example, the terminal device 110) may comprise means for performing the respective steps of the method 600. The means may be implemented in any suitable form. For example, the means may be implemented in a circuitry or software module.

In some embodiments, the apparatus comprises: means for receiving, from an access network device, an indication that an acknowledgement for application data from the terminal device is to be deferred; and means for avoiding retransmitting the application data based on the indication.

In some embodiments, the access network device has discontinuous connectivity with a core network.

In some embodiments, the indication comprises at least one of: information indicating that the access network device is in a store-and-forward mode, information indicating that a packet from the terminal device is stored in the access network device for forwarding, a resume time indicating a time for delivery of the acknowledgement, or a token generated based on a number of previous data transmissions between the terminal device and the core network.

In some embodiments, the means for receiving the indication may comprise means for receiving the indication via at least one of: a radio resource control, RRC, connection release message, system information, a random access response, RAR, message or a contention resolution message.

In some embodiments, the apparatus may further comprise means for performing, prior to retransmission of the application data, at least one of the following based on receiving a RRC connection release message comprising the indication: indicating, to an application layer of the terminal device, delivery confirmations for a plurality of packets for the application data given to an access stratum, AS, layer of the terminal device, or indicating the application layer to wait for the deferred acknowledgement.

In some embodiments, the apparatus may further comprise means for performing at least one of the following based on receiving a RRC connection release message comprising the indication: indicating, to an application layer of the terminal device, a delivery confirmation for each packet data convergence protocol service data unit, PDCP SDU, for the application data with an indication to wait for the deferred acknowledgement.

In some embodiments, the means for receiving the indication may comprise means for receiving the indication by: receiving system information or a RAR message indicating that the access network device is in a store-and-forward mode, prior to transmitting the application data to the access network device.

In some embodiments, the apparatus may further comprise means for transmitting, to the access network device, release assistance information, RAI, indicating that a final packet for the application data is transmitted and the acknowledgement is pending; and means for receiving, from the access network device, a RRC connection release message comprising a resume time indicating a time for delivery of the acknowledgement.

In some embodiments, the apparatus may further comprise means for generating, by an AS layer of the terminal device, the RAI with a flag indicating that the final packet for the application data is transmitted and the acknowledgement is pending.

In some embodiments, the apparatus may further comprise means for receiving, from the access network device and prior to receiving the RRC connection release message, pending downlink data received from the core network during last connectivity between the core network and the access network device.

In some embodiments, the apparatus may further comprise means for transmitting, to the access network device, a RRC connection resume request comprising the application data and RAI indicating that a downlink packet is expected, prior to receiving the indication via a RRC connection release message or via a contention resolution message.

In some embodiments, the apparatus may further comprise means for transmitting, to the access network device, an early data transmission request comprising the application data as a non-access stratum, NAS, message, prior to receiving a contention resolution message comprising a token generated based on a number of previous early data transmissions between the terminal device and the core network.

In some embodiments, the number of previous early data transmissions are associated with an attach procedure or a previous NAS message.

In some embodiments, the token is generated based on an s-temporary mobile subscription identifier, S-TMSI, for the terminal device and the number of previous early data transmissions between the terminal device and the core network.

In some embodiments, the apparatus may further comprise means for receiving, from the access network device, auto resume information indicating the terminal device to trigger an early data transmission, EDT, procedure or a RRC connection procedure to obtain the acknowledgement during next connectivity with the access network device without waiting for paging.

In some embodiments, the apparatus may further comprise means for receiving a duration from the access network device; and means for triggering the EDT procedure or the RRC connection procedure to obtain the acknowledgement after the duration from receipt of the acknowledgement.

In some embodiments, the means for receiving the auto resume information may comprise means for receiving the auto resume information via a RRC connection release message or system information.

In some embodiments, the apparatus further comprises means for performing other steps in some embodiments of the method 600. In some embodiments, the means comprises at least one processor; and at least one memory including computer program code, the at least one memory and computer program code configured to, with the at least one processor, cause the performance of the apparatus.

In some embodiments, an apparatus capable of performing any of the method 700 (for example, the access network device 120) may comprise means for performing the respective steps of the method 700. The means may be implemented in any suitable form. For example, the means may be implemented in a circuitry or software module.

In some embodiments, the apparatus comprises: means for determining, at an access network device, that an acknowledgement for application data from a terminal device is to be deferred; and means for transmitting, to the terminal device, an indication that the acknowledgement is to be deferred, the terminal device being configured to avoid retransmitting the application data based on the indication.

In some embodiments, the access network device has discontinuous connectivity with a core network.

In some embodiments, the indication comprises at least one of: information indicating that the access network device is in a store-and-forward mode, information indicating that a packet from the terminal device is stored in the access network device for forwarding, a resume time indicating a time for delivery of the acknowledgement, or a token generated based on a number of previous data transmissions between the terminal device and the core network.

In some embodiments, the means for transmitting the indication may comprise means for transmitting the indication via at least one of: a radio resource control, RRC, connection release message, system information, a random access response, RAR, message or a contention resolution message.

In some embodiments, the apparatus may further comprise means for receiving, from the terminal device, the application data in a RRC connected mode, prior to transmitting the indication to the terminal device via a RRC connection release message indicating at least one of information indicating that a packet from the terminal device is stored in the access network device for forwarding, or a resume time indicating a time for delivery of the acknowledgement.

In some embodiments, the means for transmitting the indication may comprise means for transmitting the indication by: transmitting, to the terminal device, system information or a RAR message indicating that the access network device is in a store-and-forward mode prior to receiving the application data from the terminal device.

In some embodiments, the apparatus may further comprise means for receiving, from the terminal device, release assistance information, RAI, indicating that a final packet for the application data is transmitted and the acknowledgement is pending; and means for transmitting, to the terminal device, a RRC connection release message comprising a resume time indicating a time for delivery of the acknowledgement.

In some embodiments, the apparatus may further comprise means for transmitting, to the terminal device and prior to transmitting the RRC connection release message, pending downlink data received from the core network during last connectivity between the core network and the access network device.

In some embodiments, the apparatus may further comprise means for receiving, from the core network, an token generated based on a number of previous early data transmissions between the terminal device and the core network; and means for receiving, from the terminal device, an early data transmission request comprising the application data as a non-access stratum, NAS, message, prior to transmitting a contention resolution message comprising the token to the terminal device.

In some embodiments, the number of previous early data transmissions are associated with an attach procedure or a previous NAS message.

In some embodiments, the token is generated based on an s-temporary mobile subscription identifier, STMSI, for the terminal device and the number of previous early data transmissions between the terminal device and the core network.

In some embodiments, the apparatus may further comprise means for transmitting, to the terminal device, auto resume information indicating the terminal device to trigger an early data transmission, EDT, procedure or a RRC connection procedure to obtain the acknowledgement during next connectivity with the access network device without waiting for paging.

In some embodiments, the apparatus may further comprise means for transmitting a duration to the terminal device, the terminal device being configured to trigger the EDT procedure or the RRC connection procedure to obtain the acknowledgement after the duration from receipt of the acknowledgement.

In some embodiments, the means for transmitting the auto resume information may comprise means for transmitting the auto resume information via a RRC connection release message or system information.

In some embodiments, the apparatus further comprises means for performing other steps in some embodiments of the method 700. In some embodiments, the means comprises at least one processor; and at least one memory including computer program code, the at least one memory and computer program code configured to, with the at least one processor, cause the performance of the apparatus.

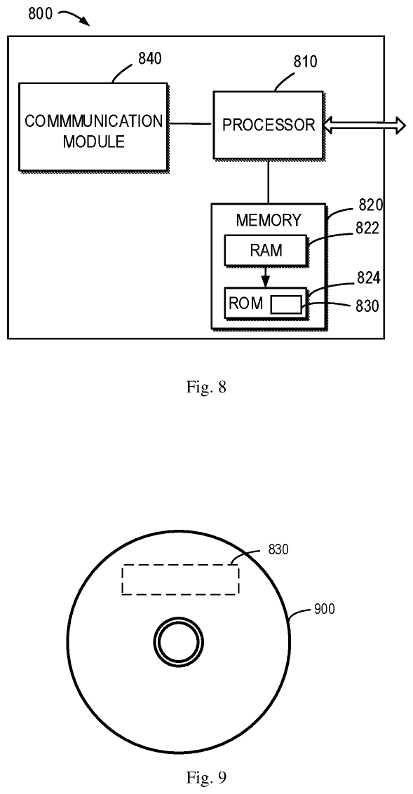

FIG. 8 is a simplified block diagram of a device 800 that is suitable for implementing embodiments of the present disclosure. The device 800 may be provided to implement the communication device, for example the terminal device 110 or the access network device 120 as shown in FIG. 1. As shown, the device 800 includes one or more processors 810, one or more memories 840 coupled to the processor 810, and one or more communication modules 840 coupled to the processor 810.

The communication module 840 is for bidirectional communications. The communication module 840 has at least one antenna to facilitate communication. The communication interface may represent any interface that is necessary for communication with other network elements.

The processor 810 may be of any type suitable to the local technical network and may include one or more of the following: general purpose computers, special purpose computers, microprocessors, digital signal processors (DSPs) and processors based on multicore processor architecture, as non-limiting examples. The device 800 may have multiple processors, such as an application specific integrated circuit chip that is slaved in time to a clock which synchronizes the main processor.

The memory 820 may include one or more non-volatile memories and one or more volatile memories. Examples of the non-volatile memories include, but are not limited to, a Read Only Memory (ROM) 824, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 822 and other volatile memories that will not last in the power-down duration.

A computer program 830 includes computer executable instructions that are executed by the associated processor 810. The program 830 may be stored in the ROM 824. The processor 810 may perform any suitable actions and processing by loading the program 830 into the RAM 822.

The embodiments of the present disclosure may be implemented by means of the program 830 so that the device 800 may perform any process of the disclosure as discussed with reference to FIGS. 2 to 7. The embodiments of the present disclosure may also be implemented by hardware or by a combination of software and hardware.

In some embodiments, the program 830 may be tangibly contained in a computer readable medium which may be included in the device 800 (such as in the memory 820) or other storage devices that are accessible by the device 800. The device 800 may load the program 830 from the computer readable medium to the RAM 822 for execution. The computer readable medium may include any types of tangible non-volatile storage, such as ROM, EPROM, a flash memory, a hard disk, CD, DVD, and the like. FIG. 9 shows an example of the computer readable medium 900 in form of CD or DVD. The computer readable medium has the program 830 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method 600 or 700 as described above with reference to FIGS. 1-7. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. The term “non-transitory,” as used herein, is a limitation of the medium itself (i.e., tangible, not a signal) as opposed to a limitation on data storage persistency (e.g., RAM vs. ROM).

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1-36. (canceled)

37. A terminal device comprising:
at least one processor; and
at least one memory storing instructions that, when executed by the at least one processor, cause the terminal device at least to:
receive, from an access network device, an indication that an acknowledgement for application data from the terminal device is to be deferred; and
avoid retransmitting the application data based on the indication.

38. The terminal device of claim 37, wherein the access network device has discontinuous connectivity with a core network.

39. The terminal device of claim 38, wherein the indication comprises at least one of:
information indicating that the access network device is in a store-and-forward mode, information indicating that a packet from the terminal device is stored in the access network device for forwarding,
a resume time indicating a time for delivery of the acknowledgement, or
a token generated based on a number of previous data transmissions between the terminal device and the core network.

40. The terminal device of claim 37, wherein the terminal device is caused to receive the indication via at least one of:
a radio resource control, RRC, connection release message,
system information,
a random access response, RAR, message or
a contention resolution message.

41. The terminal device of claim 37, wherein the terminal device is further caused to perform, prior to retransmission of the application data, at least one of the following based on receiving a RRC connection release message comprising the indication:
indicating, to an application layer of the terminal device, delivery confirmations for a plurality of packets for the application data given to an access stratum, AS, layer of the terminal device, or
indicating the application layer to wait for the deferred acknowledgement.

42. The terminal device of claim 37, wherein the terminal device is further caused to perform at least one of the following based on receiving a RRC connection release message comprising the indication:
indicating, to an application layer of the terminal device, a delivery confirmation for each packet data convergence protocol service data unit, PDCP SDU, for the application data with an indication to wait for the deferred acknowledgement.

43. The terminal device of claim 38, wherein the terminal device is caused to perform one or both of:
receive the indication by:
receiving system information or a RAR message indicating that the access network device is in a store-and-forward mode, prior to transmitting the application data to the access network device; or
transmitting, to the access network device, release assistance information, RAI, indicating that a final packet for the application data is transmitted and the acknowledgement is pending; and
receiving, from the access network device, a RRC connection release message comprising a resume time indicating a time for delivery of the acknowledgement.

44. The terminal device of claim 43, wherein the terminal device is further caused to perform one or both of:
generate, by an AS layer of the terminal device, the RAI with a flag indicating that the final packet for the application data is transmitted and the acknowledgement is pending; or
receive, from the access network device and prior to receiving the RRC connection release message, pending downlink data received from the core network during last connectivity between the core network and the access network device.

45. The terminal device of claim 37, wherein the terminal device is further caused to:
transmit, to the access network device, a RRC connection resume request comprising the application data and RAI indicating that a downlink packet is expected, prior to receiving the indication via a RRC connection release message or via a contention resolution message.

46. The terminal device of claim 38, wherein the terminal device is further caused to:
transmit, to the access network device, an early data transmission request comprising the application data as a non-access stratum, NAS, message, prior to receiving a contention resolution message comprising an token generated based on a number of previous early data transmissions between the terminal device and the core network, wherein the number of previous early data transmissions are associated with an attach procedure or a previous NAS message.

47. The terminal device of claim 46, wherein one or both of the following is utilized by the terminal device:
the number of previous early data transmissions are associated with an attach procedure or a previous NAS message, or
the token is generated based on an s-temporary mobile subscription identifier, S-TMSI, for the terminal device and the number of previous early data transmissions between the terminal device and the core network.

48. The terminal device of claim claims 37, wherein the terminal device is further caused to perform one or both of:
receive, from the access network device, auto resume information indicating the terminal device to trigger an early data transmission, EDT, procedure or a RRC connection procedure to obtain the acknowledgement during next connectivity with the access network device without waiting for paging; or
receive a duration from the access network device; and
trigger the EDT procedure or the RRC connection procedure to obtain the acknowledgement after the duration from receipt of the acknowledgement.

49. The terminal device of claim 48, wherein the terminal device is caused to receive the auto resume information via a RRC connection release message or system information.

50. An access network device comprising:
at least one processor; and
at least one memory storing instructions that, when executed by the at least one processor, cause the access network device at least to:
determine, at the access network device, that an acknowledgement for application data from a terminal device is to be deferred; and
transmit, to the terminal device, an indication that the acknowledgement is to be deferred, the terminal device being configured to avoid retransmitting the application data based on the indication.

51. The access network device of claim 50, wherein the access network device has discontinuous connectivity with a core network.

52. The access network device of claim 51, wherein the indication comprises at least one of:
information indicating that the access network device is in a store-and-forward mode, information indicating that a packet from the terminal device is stored in the access network device for forwarding,
a resume time indicating a time for delivery of the acknowledgement, or
a token generated based on a number of previous data transmissions between the terminal device and the core network.

53. The access network device of claim 50, wherein the access network device is caused to transmit the indication via at least one of:
a radio resource control, RRC, connection release message, system information,
a random access response, RAR, message or
a contention resolution message.

54. The access network device of claim 50, wherein the access network device is further caused to:
receive, from the terminal device, the application data in a RRC connected mode, prior to transmitting the indication to the terminal device via a RRC connection release message indicating at least one of information indicating that a packet from the terminal device is stored in the access network device for forwarding, or a resume time indicating a time for delivery of the acknowledgement.

55. access network device of claim 51, wherein the access network device is caused to transmit the indication by:
transmitting, to the terminal device, system information or a RAR message indicating that the access network device is in a store-and-forward mode prior to receiving the application data from the terminal device.

56. The access network device of claim 55, wherein the access network device is further caused to:
receive, from the terminal device, release assistance information, RAI, indicating that a final packet for the application data is transmitted and the acknowledgement is pending; and
transmit, to the terminal device, a RRC connection release message comprising a resume time indicating a time for delivery of the acknowledgement.
